(19) United States
(12) Patent Application Publication
(10) Pub. No.: US 2008/0311373 A1
(43) Pub. Date: Dec. 18, 2008

(54) Electromagnetic wave absorbing material and method for preparing the same

(76) Inventors: Jen-Sung Hsu, Taipei (TW); Yuan-Yao Li, Min-Hsiung (TW); Meng-Tan Chiang, Bade (TW); Chia-Tung Liu, Longtan Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,602

(22) Filed: Jun. 12, 2007

(51) Int. Cl. B32B 17/12; B29C 44/12

(52) U.S. Cl. 428/293.4; 264/45.3

(57) ABSTRACT

An electromagnetic wave absorbing material and a method for preparing the same are disclosed. The electromagnetic wave absorbing material consists of liquid resin, carbon nanocapsules, carbon fiber and hollow glass microsphere. All components are mixed well to form the electromagnetic-wave absorbing material. The method for preparing the electromagnetic-wave absorbing materials includes steps of: mixing the liquid resin, carbon nanocapsules, carbon fiber and hollow glass microsphere well to form a slurry solution; pour the slurry solution into a mold; after curing and cooling, an electromagnetic-wave absorbing material is obtained. The electromagnetic-wave absorbing material with density ranging from 0.75 to 1.0 g/ml matches requirements of compact design and light weight in high technology industries.

### BACKGROUND OF THE INVENTION

The present invention relates to an electromagnetic-wave absorbing material and a method for preparing the same, especially to an electromagnetic-wave absorbing material whose density ranges from 0.75 to 1.0 g/ml and a method for preparing the same. The electromagnetic-wave absorbing material is applied to electromagnetic-wave absorption.

Refer to Taiwanese patent No. 469283, a manufacturing method for dielectric electromagnetic-wave absorbing material is disclosed. A plurality of materials having carbon black, carbon powder, conductive fiber and hollow glass microsphere are added into liquid Polyurethane (PU) resin and are mixed by a special two-stage device to form a slurry semi-finished product. Then by a suitable mold, the slurry semi-finished product is made into microwave absorbing material. Due to high viscosity of the slurry semi-finished product, firstly the resin is only mixed with part of the carbon black and then the mixture is dispersed by a high speed 3000-6000 rpm grinder. Next the carbon powder, conductive fiber and hollow glass microsphere are added and now the viscosity of semi-finished product increases dramatically. Thus a low-speed 300-600 rpm grinder is used to mix well and then coat it on a test piece. Therefore, the manufacturing processes and necessary equipment are more complicated.

Refer to Taiwanese patent No. 567643, an improved Salbury Screen type electromagnetic-wave absorbing material is disclosed. A microwave absorbing material includes a composite layer and a reflective layer while the composite layer is formed by a first layer and a second layer. The first layer is made from homogeneous electric disposable material while the second layer is made from low dielectric constant material. Thus manufacturing of such improved Salbury Screen type electromagnetic-wave absorbing material composed by double layers is more complicated than that of material having a single layer.

Refer to Taiwanese patent No. 566077, an electromagnetic-wave absorbing material with multiple layers of resin having 5-50 wt % (weight percent) Hollow carbon nanocapsules is disclosed. The density of the electromagnetic-wave absorbing material is not mentioned in this patent. Yet the estimated density of the electromagnetic-wave absorbing material made by such method ranges from 1.0 g/ml to 1.4 g/ml. Such high density can't match requirements of light weight and compact design of materials in high technology industries.

Refer to U.S. Pat. No. 6,465,098B2, a dielectric electromagnetic-wave absorbing material is composed by carbon black, carbon fiber made from Vapor Deposition Method that replaces carbon fiber made by traditional way and resin in ratio of ratio ranging from 5:1:100 to 10:10:100. After being mixed homogeneously, the mixture is made into microwave absorbing material with various thickness. By adding into the carbon fiber made from Vapor Deposition Method, the amount carbon black and traditional carbon fiber are reduced. But the estimated density of absorbing material made by this way ranges from 1.0 g/ml to 1.2 g/ml. The density is also too high.

The above methods may have too complicated manufacturing processes or the density of the products is too high to match requirements of compact design and light weight.

Thus there is a need to provide an electromagnetic-wave absorbing material and a method for preparing the same whose density is lower so as to meet material requirements of compact design and light weight in high technology industries. Moreover, the manufacturing method of the electromagnetic-wave absorbing material is more simple than conventional methods so that the manufacturing cost is reduced.

### SUMMARY OF THE INVENTION

Therefore it is a primary object of the present invention to provide an electromagnetic-wave absorbing material and a method for preparing the same which decreases density of the electromagnetic-wave absorbing materials for meeting requirements of compact design as well as light weight in high technology industries.

It is another object of the present invention to provide an electromagnetic-wave absorbing material and a method for preparing the same that include processes more easy and convenient than processes of conventional methods so as to reduce manufacturing time and cost.

It is a further object of the present invention to provide an electromagnetic-wave absorbing material and a method for preparing the same. The electromagnetic-wave absorbing materials are made from slurry solution with low viscosity that is more easier to be mixed and stirred.

An electromagnetic-wave absorbing material according to the present invention consists of liquid resin, carbon nanocapsules, carbon fiber and hollow glass microsphere. All components are mixed homogeneously to form the electromagnetic-wave absorbing material.

A method for preparing the electromagnetic-wave absorbing materials according to the present invention includes following steps: mix the liquid resin, carbon nanocapsules, carbon fiber and hollow glass microsphere well to form a solution. Pour the solution into a mold. After curing and cooling, an electromagnetic-wave absorbing material is obtained.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of a method for preparing electromagnetic wave absorbing material according to the present invention;

FIG. 2 is a return loss of an embodiment according to the present invention;

FIG. 3 is a return loss of another embodiment according to the present invention;

FIG. 4 is a return loss of a further embodiment according to the present invention;

FIG. 5 is a return loss of a further embodiment according to the present invention;

FIG. 6 is a return loss of a further embodiment according to the present invention.

### DETAILED DESCRIPTION OF THE PREFERRED EMBODIMENT

An electromagnetic-wave absorbing material according to the present invention consists of liquid resin, carbon nanocapsules (with multi-layer graphite structure), carbon fiber and hollow glass microsphere. The above materials are mixed homogeneously to form an electromagnetic-wave absorbing material. Density of the electromagnetic-wave absorbing material ranges from 0.75 g/ml to 1.0 g/ml while the thickness hereof is from 1.3 mm to 2.0 mm. The electromagnetic-wave absorbing material contains 80-90 weight percent liquid resin that is selected from epoxy, polyurethane resin, polymethacrylate resin, silicone resin, and polyester resin. The weight percent of the carbon nanocapsules is from 0.2 to 2.0% and the inner diameter of the carbon nanocapsule is from 5-10 nm while the outer diameter is 15-25 nm. The weight percent of the carbon fiber is from 5.0 to 15.0% while average length of the carbon fiber made from vapor deposition method ranges from 10 to 20 μm while average width thereof is 0.15 μm. The weight percent of the hollow glass microsphere ranges from 5.0 to 10.0% and the density thereof is from 0.15 to 0.5 g/ml with average diameter ranging from 50 μm.-55 μm.

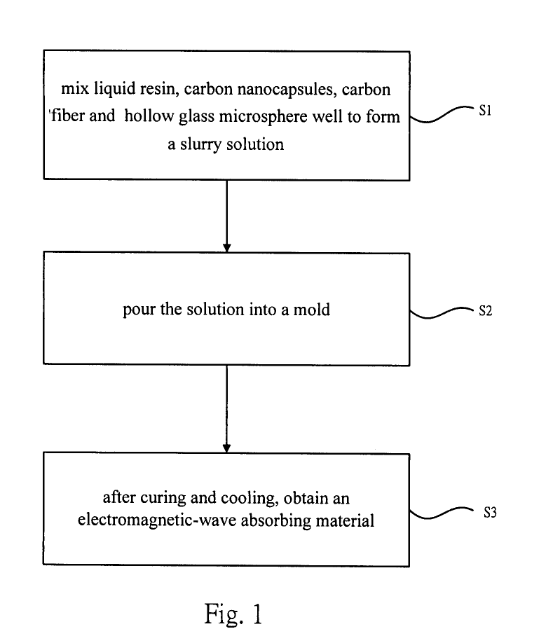

Refer to FIG. 1, a method for preparing the electromagnetic-wave absorbing material according to the present invention includes following steps:
S1 mix liquid resin, carbon nanocapsules, carbon fiber and hollow glass microsphere well to form a slurry solution;
S2 pour the solution into a mold; and
S3 after curing and cooling, obtain an electromagnetic-wave absorbing material;

wherein weight percent of the liquid resin ranges, the carbon nanocapsule, the carbon fiber and the hollow glass microsphere respectively range 80-90%, 0.2-2.0%, 5.0-15.0% and 5.0-10.0% of the mixtures.

In the step S1, it further includes a step of using a blade mixer with blade speed 1000-3000 rpm to stir the slurry solution. Firstly, the liquid resin ranges, the carbon nanocapsule, and the carbon fiber are mixed and then the hollow glass microsphere is added into the mixture and is mixed homogeneously while the viscosity of the mixture is from 11500 to 20500 cps. In the step of S3, the curing process is heated for 0.8˜1.5 hour under 70˜90 degrees Celsius.

Due to good conductivity as well as chemical stability, the carbon nanocapsule is getting more attention. Before carbon black is added in dielectric electromagnetic-wave absorbing material so that viscosity of the slurry semi-finished product is high and the processability is poor. Thus in the present invention, part of the carbon black is replaced by the carbon nanocapsule to improves above shortcomings and simultaneously certain amount of hollow glass microsphere is added into the mixture for reducing the density of the electromagnetic-wave absorbing material.

In order to improve the mixing way in Taiwanese Patent No. 469283, a general blade mixer is used to mix all the materials. However, such device can only mix slurry with density lower than 25000 cps. Thus only liquid resin is applied while the carbon nanocapsule, the carbon fiber made from vapor deposition and the hollow glass microsphere can only be added in limited amount so as to prevent high viscosity of the slurry.

When the electromagnetic-wave is transmitted to the absorbing material with conductive metal layer on rear side thereof through the air, reflective index of the electromagnetic-wave of the interface between the air and the absorbing material is calculated as following equation:

$$ρ = \frac{{Z}_{2} tanh ( {γ}_{2} {d}_{2} ) - {Z}_{1}}{{Z}_{2} tanh ( {γ}_{2} {d}_{2} ) + {Z}_{1}} \qquad ( 1 )$$

return loss-dB value is defined as:

ρ(dB)=10 log(|ρ|²) (2)
subscript 1 represents air, subscript 1 represents absorbing material, ρ is the reflective index that is a ratio of the incident wave power to reflected wave power, d is thickness of the absorbing material, and γ₂ is propagation coefficient of the electromagnetic wave in the absorbing material:

γ₂=\sqrt{−w²∈₂μ₂} (3)
Z₁ and Z₂ respective present impedance of the air and the absorbing material:

$$\begin{matrix}{Z}_{1} = {Z}_{0} = \sqrt{\frac{{μ}_{0}}{{ɛ}_{0}}} = 377 Ω & ( 4 ) \\ {Z}_{2} = \sqrt{\frac{{μ}_{2}}{{ɛ}_{2}}} & ( 5 )\end{matrix}$$

∈ and μ respectively represent permittivity and permeability of the material because the absorbing material is polarized under the electromagnetic field and there is time delay. That means there is a loss.

The relative dielectric constant ∈, and the relative permeability μ, of the absorbing material to the air are as followings:

$$\begin{matrix}{ɛ}_{r} = \frac{{ɛ}_{2}}{{ɛ}_{o}} = \frac{{ɛ}_{2}^{′} - j {ɛ}_{2}^{″}}{{ɛ}_{o}} = {ɛ}_{r}^{′} - j {ɛ}_{r}^{″} & ( 6 ) \\ {μ}_{r} = \frac{{μ}_{2}}{{μ}_{o}} = \frac{{μ}_{2}^{′} - j {μ}_{2}^{″}}{{μ}_{o}} = {μ}_{r}^{′} - j {μ}_{r}^{″} & ( 7 )\end{matrix}$$

Once there is no reflection, the following equation is derived from the equation (1):

Z₂ tan h(γ₂d₂)−Z₁=0 (8)

Therefore, certain kind of conductive material or magnetic material is selected and the amount as well as thickness thereof are controlled so as to get excellent absorbing material.

The electromagnetic absorbing material according to the present invention is produced by adding the dielectric materials such as carbon nanocapsule, carbon fiber made from vapor deposition and hollow glass microsphere into liquid resin. Then a general blade mixer with speed from 1000 to 3000 rpm is used to mix the mixture well and the solution viscosity is detected by a Brookfield Viscometer at 25 degrees Celsius. The slurry mixture is poured into a 15 cm×15 cm metal mold. The top and the bottom sides thereof are respectively covered by aluminum plates that are clipped. The mold is heated at 80 degrees Celsius for an hour (curing step). After cooling, the aluminum plates are removed and the product is released. After finishing, measure thickness, weight and density of the final material.

The way to measure return loss is a free space method with frequency from 2-18 GHz by an HP-8722ES network analyzer and free space setups of Damaskos, Inc. A 15 cm×15 cm metal test piece is set on the device. Firstly, do the level calibration. Then adjust incident angle (21°) of the antenna to measure origin reflection. The change the test piece and use the metal piece as reflection surface to measure attenuation of the reflection.

### THE FIRST EMBODIMENT

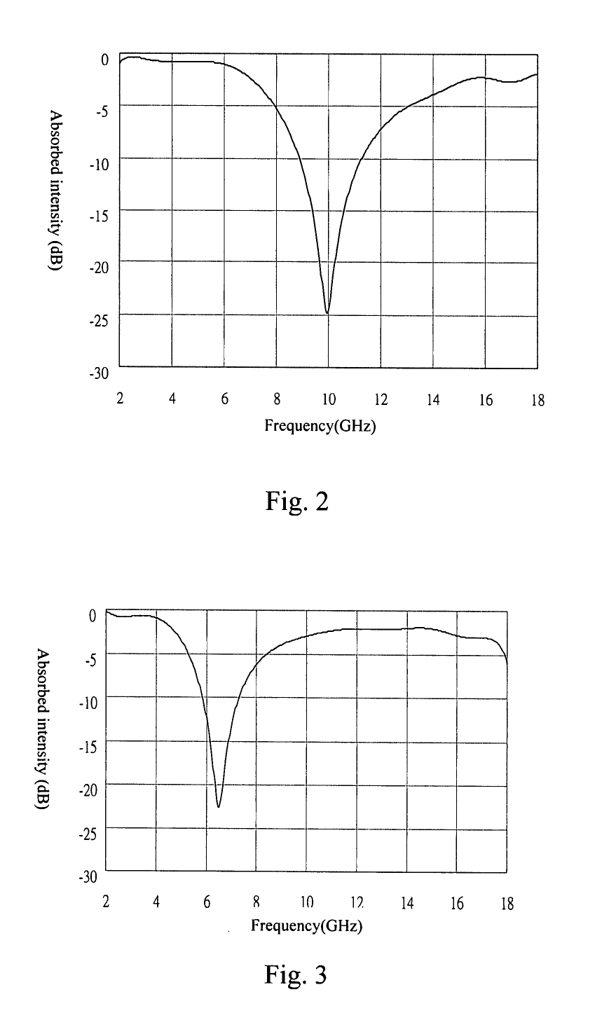

Put 83.1 g liquid epoxy resin, 0.9 g carbon nanocapsule, 8.0 g vapor grown carbon fiber (VGCF-H) into a container for mixture and use a general blade mixer in speed of 3000 rpm to stir the mixture for 5 minutes. Then add 8.0 g hollow glass microsphere (total weight of the material is 100 g) and stir the mixture again in speed of 1000 rpm for 4 minutes. Take a sample to measure the viscosity and it's 20500 cps. Pour 34.0 g mixture solution into the mold. After curing, release a test piece and measure the weight, thickness and density thereof. The weight is 32.0 g with thickness of 1.8 mm and density of 0.79 g/cc. The return loss is shown in FIG. 2 with 24.5 dB and the peak is at 9.9 GHz. Features of the sample according to the present invention are compared with those of a test piece of the embodiment in U.S. Pat. No. 6,465,098B2 that is made from 6.4% conductive carbon black, 2.7% conductive carbon fiber, and 90.9% polyethylene with thickness of 1.98 mm. The return loss thereof is 37 dB and the peak is at 9.5 GHz. The peak values of the two test pieces are quite near while the thickness of the present invention is about 10% less than the thickness of the embodiment of the prior art. Although the density of the test piece of the prior art is not mentioned, the estimated density according to the composition is about 1.0 g/cc. Thus in the same frequency band, weight of the test piece of the present invention is reduced about 30% because of low density and small thickness.

### THE SECOND EMBODIMENT

The same composition and preparation method as the first embodiment, take 55.0 g mixture solution and fill it into the mold. Release and measure the test piece after curing. The weight is 49.3 g, the thickness is 2.7 mm and the density is 0.79 g/cc. As shown in FIG. 3, the return loss is 22.6 dB and the peak is at 6.5 GHz.

### THE THIRD EMBODIMENT

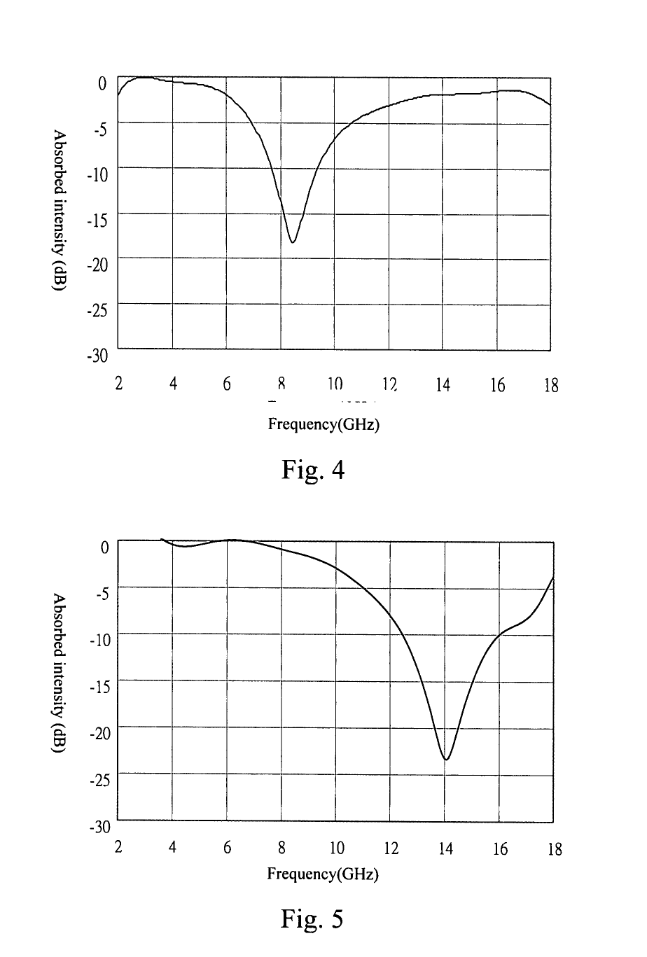

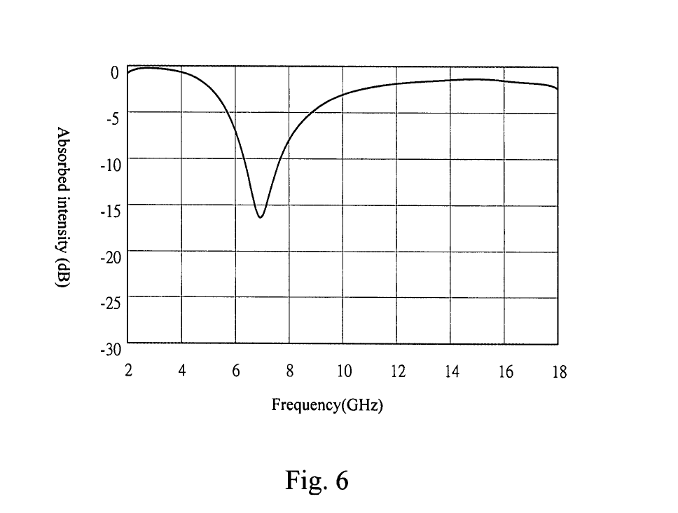

Put 85.15 g liquid epoxy resin, 0.45 g carbon nanocapsule, 9.0 g vapor grown carbon fiber (VGCF-H) into a container for mixture and use a general blade mixer in speed of 3000 rpm to stir the mixture for 5 minutes. Then add 5.4 g hollow glass microsphere (total weight of the material is 100 g) and stir the mixture again in speed of 1000 rpm for 4 minutes. Take a sample to measure the viscosity and it's 17600 cps. Pour 38.0 g mixture solution into the mold. After curing, release a test piece and measure the weight, thickness and density thereof. The weight is 35.3 g with thickness of 1.8 mm and density of 0.87 g/cc. The return loss is 18.1 dB, as shown in FIG. 4 and the peak is at 8.5 GHz.

### THE FOURTH EMBODIMENT

Put 82.8 g liquid epoxy resin, 1.2 g carbon nanocapsule, 6.0 g vapor grown carbon fiber (VGCF-H) into a container for mixture and use a general blade mixer in speed of 3000 rpm to stir the mixture for 5 minutes. Then add 10.0 g hollow glass microsphere (total weight of the material is 100 g) and stir the mixture again in speed of 1000 rpm for 5 minutes. Take a sample to measure the viscosity and it's 11500 cps. Pour 28.0 g mixture solution into the mold. After curing, release a test piece and measure the weight, thickness and density thereof. The weight is 26.1 g with thickness of 1.3 mm and density of 0.89 g/cc. The return loss is 23.3 dB, as shown in FIG. 5 and the peak is at 14.1 GHz.

### THE FIFTH EMBODIMENT

Put 82.15 g liquid epoxy resin, 0.35 g carbon nanocapsule, 9.5 g vapor grown carbon fiber (VGCF-H) into a container for mixture and use a general blade mixer in speed of 3000 rpm to stir the mixture for 6 minutes. Then add 5.0 g hollow glass microsphere (total weight of the material is 100 g) and stir the mixture again in speed of 1000 rpm for 3 minutes. Take a sample to measure the viscosity and it's 19500 cps. Pour 48.0 g mixture solution into the mold. After curing, release a test piece and measure the weight, thickness and density thereof. The weight is 45.2 g with thickness of 2.0 mm and density of 1.00 g/cc. The return loss is 16.2 dB, as shown in FIG. 5 and the peak is at 7.0 GHz.

In summary, density of the electromagnetic-wave absorbing material according to the present invention ranges from 0.75 to 1.0 g/ml and material made by the method for preparing the electromagnetic-wave absorbing material has lower density than those made by prior arts so that such material meets requirements of light weight and compact design of materials in high technology industries. Moreover, the slurry solution of the electromagnetic-wave absorbing material has lower viscosity that is easy to mix and stir. Furthermore, the method for preparing the same is more easy and convenient than prior arts so that preparation time and cost are reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An electromagnetic-wave absorbing material comprising
liquid resin, carbon nanocapsule, carbon fiber and hollow glass microsphere;
wherein the liquid resin, the carbon nanocapsule, the carbon fiber and the hollow glass microsphere are mixed homogeneously to form the electromagnetic-wave absorbing material.

2. The electromagnetic-wave absorbing material as claimed in claim 1, wherein density of the electromagnetic-wave absorbing material ranges from 0.75 to 1.0 g/ml.

3. The electromagnetic-wave absorbing material as claimed in claim 1, wherein thickness of the electromagnetic-wave absorbing material ranges from 1.3 to 2.0 mm.

4. The electromagnetic-wave absorbing material as claimed in claim 1, wherein the electromagnetic-wave absorbing material contains 80-90 weight percent of the liquid resin.

5. The electromagnetic-wave absorbing material as claimed in claim 1, wherein the liquid resin is epoxy resin, polyurethane resin, polymethacrylate resin, silicone resin, or polyester resin.

6. The electromagnetic-wave absorbing material as claimed in claim 1, wherein the electromagnetic-wave absorbing material having 0.2 to 2.0% weight percent of the carbon nanocapsule.

7. The electromagnetic-wave absorbing material as claimed in claim 1, wherein inner diameter of the carbon nanocapsule is from 5 to 10 nm while outer diameter thereof is 15 to 25 nm.

8. The electromagnetic-wave absorbing material as claimed in claim 1, wherein the electromagnetic-wave absorbing material having 5.0 to 15.0% weight percent of the carbon fiber.

9. The electromagnetic-wave absorbing material as claimed in claim 1, wherein the carbon fiber is made by vapor deposition method.

10. The electromagnetic-wave absorbing material as claimed in claim 1, wherein average length of the carbon fiber ranges from 10 to 20 μm while average width thereof is 0.15 μm.

11. The electromagnetic-wave absorbing material as claimed in claim 1, wherein the electromagnetic-wave absorbing material having 5.0 to 10.0% weight percent of the hollow glass microsphere.

12. The electromagnetic-wave absorbing material as claimed in claim 1, wherein average diameter of the hollow glass microsphere ranges from 50 μm.-55 μm

13. The electromagnetic-wave absorbing material as claimed in claim 1, wherein density of the hollow glass microsphere is from 0.15 to 0.5 g/ml.

14. A method for preparing electromagnetic-wave absorbing materials comprising the steps of:
mixing liquid resin, carbon nanocapsule, carbon fiber and hollow glass microsphere well to form a slurry; pouring the slurry into a mold; and
getting an electromagnetic-wave absorbing material after curing and cooling.

15. The method for preparing electromagnetic-wave absorbing materials as claimed in claim 14, wherein the slurry solution having 80-90 weight percent of the liquid resin.

16. The method for preparing electromagnetic-wave absorbing materials as claimed in claim 14, wherein the slurry solution having 0.2 to 2.0% weight percent of the carbon nanocapsule.

17. The method for preparing electromagnetic-wave absorbing materials as claimed in claim 14, wherein the slurry solution having 5.0 to 15.0% weight percent of the carbon fiber.

18. The method for preparing electromagnetic-wave absorbing materials as claimed in claim 14, wherein the slurry solution having 5.0 to 10.0% weight percent of the hollow glass microsphere.

19. The method for preparing electromagnetic-wave absorbing materials as claimed in claim 14, the step of mixing liquid resin, carbon nanocapsule, carbon fiber and hollow glass microsphere well to form a slurry further comprising a step of: using a blade mixer to stir the slurry.

20. The method for preparing electromagnetic-wave absorbing materials as claimed in claim 19, wherein blade speed of the blade mixer is from 1000 to 3000 rpm.

21. The method for preparing electromagnetic-wave absorbing materials as claimed in claim 14, the step of mixing liquid resin, carbon nanocapsule, carbon fiber and hollow glass microsphere well to form a slurry solution further comprising a step of: firstly mixing the liquid resin, the carbon fiber and the hollow glass microsphere and then adding the hollow glass microsphere.

22. The method for preparing electromagnetic-wave absorbing materials as claimed in claim 14, wherein viscosity of the slurry solution ranges from 11500 cps to 20500 cps.

23. The method for preparing electromagnetic-wave absorbing materials as claimed in claim 14, wherein in the step of getting an electromagnetic-wave absorbing material after curing and cooling, the curing is heated for 0.8˜1.5 hour under 70˜90 degrees Celsius.
